(19) United States
(12) Patent Application Publication
(10) Pub. No.: US 2010/0086280 A1
(43) Pub. Date: Apr. 8, 2010

(54) METHOD FOR SMOOTHLY PLAYING A VIDEO STREAM IN REVERSE

(75) Inventor: Doron Sabo, Natanya (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/244,220

(22) Filed: Oct. 2, 2008

(51) Int. Cl. H04N 5/91

(52) U.S. Cl. 386/68

(57) ABSTRACT

The present invention relates to a method for displaying a video stream in reverse smoothly comprising the steps of: (a) determining at least one GOP for reverse display; (b) selecting all the frames of said GOP, a subsequent I frame and if present, the B frames positioned between said subsequent I frame and the next I or P frame, in the encoded order, into a selected group; (c) if present, discarding from said selected group the B frames that are positioned between the primary I frame of said GOP and the next I or P frame, in the encoded order; (d) decoding and storing the remaining frames of said selected group; and (e) loading for display at least one of said decoded frames in a reverse display order.

### FIELD OF THE INVENTION

The present invention relates to the field of digital video playback. More particularly, the invention relates to a method for playing a video stream in reverse, smoothly, without skipping any frames.

### BACKGROUND OF THE INVENTION

Due to the nature of the digital video encoding of the various standards, providing smooth reverse play of a video stream in real time is often difficult.

As shown in FIG. 1, three types of frames are defined in the (Moving Pictures Experts Group) MPEG-1, MPEG-2, MPEG4, WM9, VC1, H.264 (defined in the ISO/IEC 14496-10) etc. standards: intra (I) frames, predicted (P) frames, and bi-directionally interpolated (B) frames. I frames provide access points for random access, but typically have a moderate compression. P frames are coded with references to previous frames (in presentation order), which are considered reference frames and in most cases are types of I frames or P frames. B frames may usually be compressed with a low bit rate, using both reference frames from the past and from the future (in presentation order). The above standards do not impose any limit to the number of non-reference frames between two reference frames. In most cases, I frames and P frames are reference frames whereas B frames are non-reference. In H.264, however, B frame can be marked as non-reference or reference frame. B frame that is marked as reference frame is called B-reference (B_{ref}), which is a B type frame that can be a reference for other frames.

A GOP (Group Of Pictures) is a group of frames that starts with an I frame (in the encoded order). A GOP can typically be accessed independently. The sequence of frames in the encoded stream is such that the encoded reference frames are always placed ahead of the encoded frames that use the reference frames. For example, if the sequence of frames in the encoded stream is IPBB (where the P frame uses the I frame as reference and both B frames use the I frame and the P frame as references), the forward display sequence will be IBBP. This type of data encoding may generally be referred to as temporal compression since this compression exploits the temporal redundancies in addition to spatial redundancies in the data. However, such a compression scheme requires that the data be decoded in the same order it is encoded. Thus, if a user wishes to see the frames displayed in reverse order, so as to back up to a particular section, the process becomes much more difficult.

Most consumer DVD players provide only limited frame display in reverse order. Since an I frame is the only type that contains all data for a complete image, without reference to data from other frames, most consumer DVD players, when set to reverse mode, will play only successive I frames in reverse order. As a result, the consumer sees a stilted “stop action” type of image, rather than a smooth reverse image. Since the number of I frames is only a fraction of the overall number of frames, reverse playback on most machines is usually at a rate of X4 X8 X16 or X32 of normal speed, making it difficult for a user to stop at a particular part of a video program.

A smooth playback of the video stream in reverse order is desirable for a number of reasons. Such a feature would allow the consumer to reverse play the images to a particular frame or section and would also provide a better reverse display, which is less disorienting than the flashing “stop action” types of displays presently used. In addition, the ability to play video in a reverse and forward direction, smoothly, better emulates the actions of tape players and other video equipment, making the use of digitally encoded data more acceptable to professional video users as a data feed source as opposed to decoded data. The ability to smooth reverse images allows a user to better edit video on a frame-by-frame basis.

The term “smooth” refers to the ability to playback all the images of a video stream in reverse display (play speed, high speed, or slow motion). The digitally encoded video does not lend itself naturally to this feature since digital video encoding exploits temporal redundancies in the forward direction, thereby constraining the order in which images can be decoded. Hence, images within a GOP have to be decoded in the order in which the data is encoded in order to produce a stream of video data.

A closed GOP is a GOP that all its frames may have reference frames only from within the GOP. In an open GOP, frames may have reference frames from other GOPs. For example, the open GOP may comprise a B frame that requires a P reference frame from the previous GOP. Open GOPs do not require any additional buffering of the stream data during normal forward-direction play, since the last reference frame of a GOP would have been decoded just before starting to decode the first frame of the subsequent GOP, thereby making the reference frame readily available to decode the subsequent open GOP frames. However, when executing a reverse smooth play operation, the open GOP frames cannot be decoded until the decoder has decoded the reference frames from the subsequent GOP (i.e. the previous GOP in a forward presentation direction).

In the H.264 standard, frames of an open GOP can branch even further by using references from non-adjacent GOPs. Frames within an open GOP in the H.264 standard may use reference frames as far as 16 reference frames away, previous or subsequent. This feature complicates the task of inverse playing even further, as the frames may require references from subsequent GOPs (i.e. previous GOPs in a forward presentation direction) which are relatively distant.

U.S. Pat. No. 7,333,714 discloses a method and system to efficiently process MPEG video in order to perform a reverse play. The disclosed method maximizes the use of memory resources when video frame buffers are implemented. The disclosed system comprises a first subsystem feeding a sequence of frames to a second subsystem. The first subsystem defines a set of parameters that is used to determine the one or more feeding sessions provided to the second subsystem. The second subsystem subsequently decodes the one or more feeding sessions using the set of parameters such that the video may be displayed. Nevertheless, the disclosed method deals with video streams containing closed GOPs only.

US 2006/0008248 discloses a method for smooth reverse play in an MPEG-type stream player, while reducing the buffering requirements. A buffering strategy is disclosed for reducing the required number of passes through the video data unit by optimal scheduling of picture decodes. Nevertheless, the described method does not deal with an H.264-type video stream.

It is an object of the present invention to provide a method for playing a video stream, comprising any number of GOPs, in reverse smoothly without skipping any frames.

It is another object of the present invention to provide a method for playing a video stream, comprising closed or open GOPs, in reverse smoothly without skipping any frames.

It is still another object of the present invention to provide a method for playing a video stream, encoded according to the H.264 standard, in reverse smoothly without skipping any frames.

It is still another object of the present invention to provide a method for error resilience while playing a video stream in reverse.

Other objects and advantages of the invention will become apparent as the description proceeds.

### SUMMARY OF THE INVENTION

The present invention relates to a method for displaying a video stream in reverse smoothly comprising the steps of: (a) determining at least one GOP for reverse display; (b) selecting all the frames of said GOP, a subsequent I frame and if present, the B frames positioned between said subsequent I frame and the next I or P frame, in the encoded order, into a selected group; (c) if present, discarding from said selected group the B frames that are positioned between the primary I frame of said GOP and the next I or P frame, in the encoded order; (d) decoding and storing the remaining frames of said selected group; and (e) loading for display at least one of said decoded frames in a reverse display order.

In one of the embodiments, all the remaining decoded frames are loaded for display.

In one of the embodiments, the remaining decoded frames are loaded for display excluding the primary I frame.

In one of the embodiments, the remaining decoded frames are loaded for display excluding the subsequent I frame.

Preferably, the storing of the frames is done in a buffer that is capable of storing more than 2 average GOPs of decoded frames.

Preferably, part of the buffer is used for loading one GOP while another part of said buffer is used for storing another GOP.

Preferably, the temporal closest decoded frame that precedes the subsequent I frame is used for error resilience in case said subsequent I frame is corrupt.

In one of the embodiments, the video stream is encoded according to any one of the following standards: MPEG-1, MPEG-2 or MPEG-4.

In one of the embodiments, the video stream is encoded according to the H.264 standard.

Preferably, a reference frame, not part of the selected group, of a frame of said selected group, is substituted by the closest temporal decoded frame of said selected group.

### BRIEF DESCRIPTION OF THE DRAWINGS

In the drawings:

FIG. 1 is a diagram illustrating the arrangement of frames in a GOP.

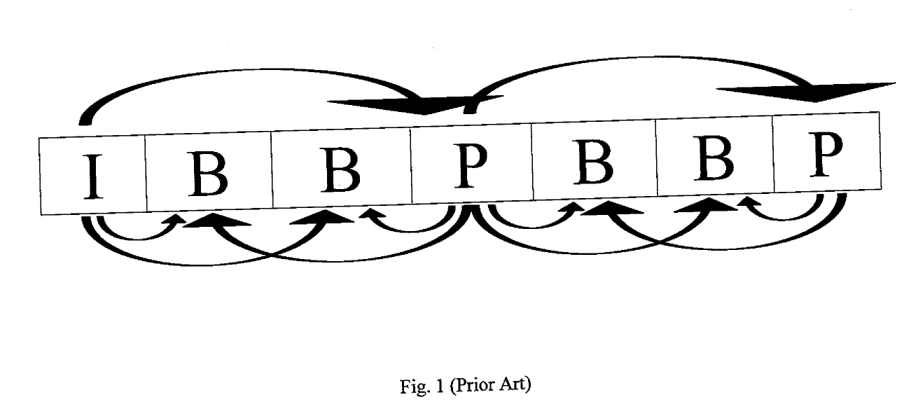

FIG. 2 is a block diagram showing the method for reverse display according to an embodiment of the invention.

FIG. 3 shows two tables representing an example of 3 consecutive GOPs in a video data stream.

FIG. 4 depicts an example of implementing the method for reverse display.

### DETAILED DESCRIPTION OF PREFERRED EMBODIMENTS

All referrals hereinafter to “reference” frames are meant to include I type frames, P type frames, or B-reference type frames.

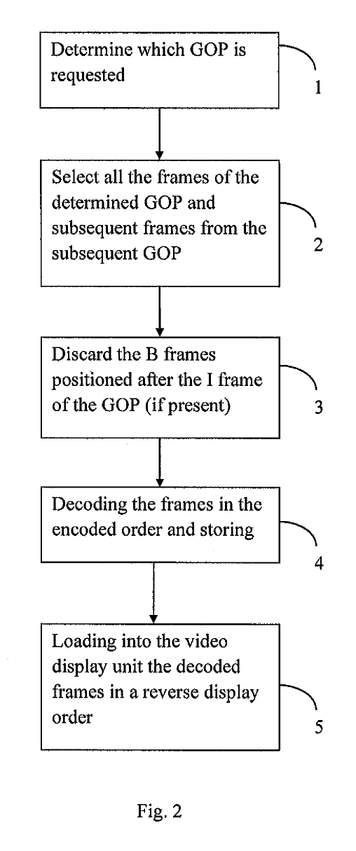

FIG. 2 is a block diagram showing the method for reverse display according to an embodiment of the invention. At first it is determined which GOP is requested for reverse display. Although the reverse display itself may begin from any frame, the decoding of the frames of any GOP must start from the GOP's primary I frame. Therefore, at step 1 a specific GOP is first determined for reverse display. In step 2, all the frames of the determined GOP are selected together with a number of subsequent (in the forward encoded direction) frames from the subsequent GOP. The subsequent frames consist of the I frame of the subsequent GOP, and if present, the subsequent B frames located between this I frame of the subsequent GOP and the next I or P reference frame. All these frames, i.e. the determined GOP's frames and its subsequent frames, are referred to hereinafter as the selected group. In step 3 the GOP's B frames, following (in the forward encoded direction) the primary I frame until the next I or P reference frame, are discarded. In case no B frames are present between the GOP's primary I frame and the next (in the forward encoded direction) I or P reference frame, then no frames are discarded. In step 4, the remaining frames of the selected group are decoded by the decoder and stored. At first, the primary I frame of the GOP is decoded, after which the rest of the frames and reference frames are decoded in the typical decoding order, as described in the standards, such as MPEG-2. Thus the decoder is capable of decoding the frames, as they are still organized in the encoded forward order. Each decoded frame is stored. The decoding and storing of the selected group of frames continues including the decoding and storing of the selected frames of the subsequent GOP. In step 5, some or all of the decoded frames are loaded into the video display unit in a reverse display order for displaying. Nevertheless, in one of the embodiments, the second I frame, belonging to the subsequent GOP, is not loaded for display. In another embodiment, the second I frame of the subsequent frames is loaded for display in its proper location in the reverse display order, while the primary I frame of the GOP is not loaded for display.

As described, the decoder of the system is oblivious to the reverse display as it is fed in the forward encoded order. In one of the embodiments, the fetching and feeding of frames to the encoder and the organizing of the frames later for reverse display is done in software, where the decoder itself is implemented in hardware, effectively lowering system production costs.

When a request is received for a reverse display of a video data stream longer than a GOP, the system can continue fetching and decoding any number of GOPs by repeating step 1-5 described in relations to FIG. 2. In one of the embodiments, the buffer storing the decoded frames is capable of storing more than 2 average GOPs of decoded frames. Thus, when one group of selected frames is displayed in reverse by loading from the buffer, the system can continue to decode and store another group of selected frames in the buffer. Thus the system can display a video data string, of any number of GOPs, in reverse, without delays and without skipping frames.

In one of the embodiments, only some of the decoded frames are eventually displayed. For example, if a request is received for a reverse display of a video data stream shorter than a GOP, the system decodes the GOP as described in steps 1-5 in relations to FIG. 2, however, only the requested frames of the data stream are loaded into the video display unit in a reverse display order for displaying.

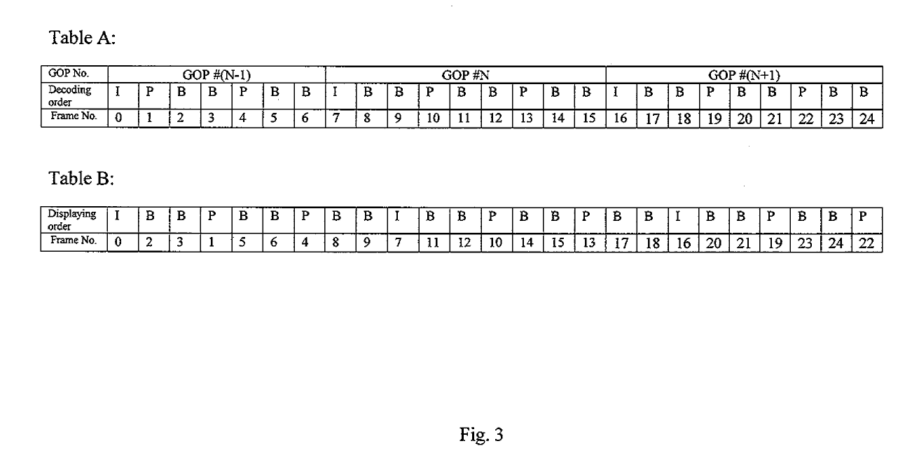

FIG. 3 shows two tables representing an example of 3 subsequent GOPs in a video data stream, where Table A represents the encoded order of the video data stream, and Table B represents the decoded order of the video data stream ready for forward display. As shown, GOP #(N−1) is actually a closed GOP, as all its frames use reference frames from within the GOP. On the other hand, GOP #N is an open GOP as its first two B frames numbered 8 and 9, i.e. frames B8 and B9, use as reference the P4 frame, which is part of GOP #(N−1). GOP #(N+1) is similarly an open GOP as well. Table B depicts the same frames of Table A, in a forward display order after decoding. The order of the frames is rearranged according to the frames appearance in the forward display of the video. For example, although B2 and B3 are to be displayed before P1, they are coded after P1, since they use the P1 as a reference frame. Thus, the decoder is required to decode P1 first before decoding B2 and B3. In another example, B8 and B9 require both frames, P4 and I7, as reference for decoding, therefore, the decoder first decodes P4 and I7 and then decodes B8 and B9, after which the frames are rearranged according to their forward display order. The arrangement of the frames is also disclosed in the standard MPEG-2.

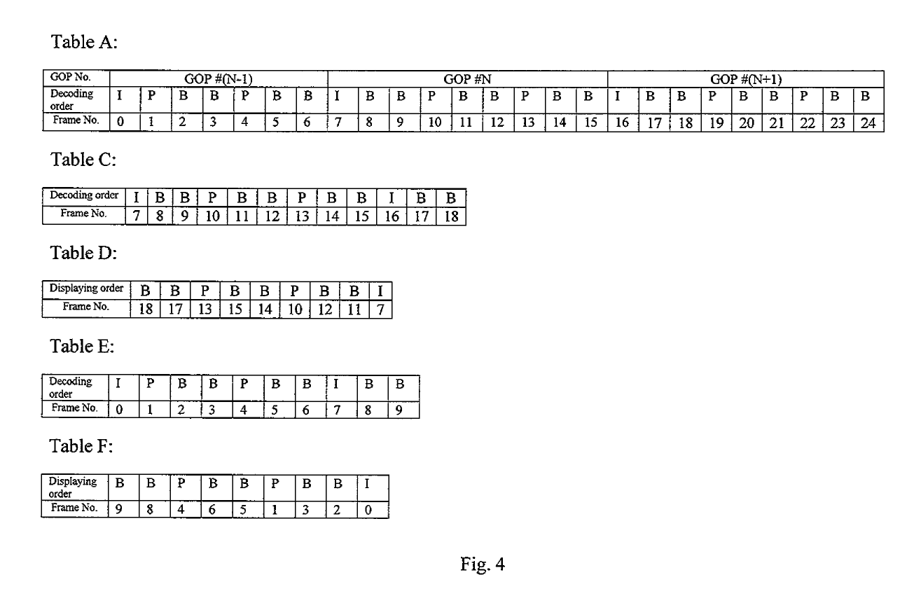

FIG. 4 depicts an example of implementing the method for reverse display. As described in relation to FIG. 3, Table A depicts the encoded video data stream, where GOP #(N−1) is a closed GOP, GOP #N and GOP #(N+1) are open GOPs. For the sake of brevity, the following explanation will deal with the reverse display of GOP #N, however, the method may be carried into practice with any other GOP regardless of its size or inner frame order. As described in relation to FIG. 2, in step 1, GOP #N is determined for reverse display. Table C shows the selected frames, where all the frames of the GOP #N are selected and 3 more subsequent frames I16, B17 and B18 are selected as well, as described in relations to step 2. Frames B8 and B9 are discarded as described in relations to step 3. Next, the remaining frames of the selected group are decoded in the typical decoding order starting from I7 until B18, including the subsequent frames I16, B17 and B18, as described in relations to step 4. Then, all the decoded frames, except I16, are uploaded into the video display unit in a reverse display order as shown in Table D and as described in relations to step 5. In this example, I16 is not displayed with this selected group, it is displayed when GOP #(N+1) is determined for reverse display. Thus the selected group of frames of this example is displayed in a reverse order. At this point if a request for continuation of the reverse play is requested, GOP #(N−1) can be determined for reverse play. As disclosed above, GOP #(N−1) is a closed GOP, however, the same method can be applied as well. Table E shows the selected frames, where all the frames of the GOP #(N−1) are selected and 3 more subsequent frames I7, B8 and B9 are selected as well, as described in relations to the step 2. At this point no frames are discarded, as GOP #(N−1) does not have B frames between the I0 frame and the P1 frame. The selected group of frames is then decoded in the typical decoding order starting from I0 until B9 and stored, after which, the decoded frames, except I7, are uploaded into the video display unit in a reverse display order as shown in Table F. Thus, reverse display may continue according to the need and request, where more GOPs are selected in a preceding order.

In some of the cases, some of the frames may be corrupted and some of their data may be lost, for example, during transmission and reception. Many methods can be used for repairing the integrity of the corrupted frames; however, a simple error resilience method calls for the use of data from other frames for repairing the corrupted frames. For example, if one of the frames has a corrupt block, a corresponding block from a previous frame may be copied and inserted instead of the corrupt block in the frame. The repairing block may be copied from a previous frame, a subsequent frame or any other decoded frame. However, if the corruption occurs in an I frame, finding a corresponding block for repairing may not be so easy. In one of the embodiments, the described method of the invention may be used for error resilience of I frames. In the embodiment where the primary I frame of the GOP is decoded but not displayed, and the I frame of the subsequent GOP is decoded and displayed, if the subsequent I frame is corrupt, the closest decoded frame that precedes this subsequent I frame can be used for error resilience.

In the H.264 standard, frames of an open GOP can use reference frames as far as 16 reference frames away, previous or subsequent. Therefore, in one of the embodiments, if a B or P frame require a reference frame that is not part of the selected group, the closest temporal decoded frame to the required reference, within the selected group, shall be used. For example, if a required reference frame is in the previous GOP (in a forward encoded direction) the first frame of the present GOP shall be used as reference instead.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for displaying a video stream in reverse smoothly comprising the steps of
a. determining at least one GOP for reverse display;
b. selecting all the frames of said GOP, a subsequent I frame and if present, the B frames positioned between said subsequent I frame and the next I or P frame, in the encoded order, into a selected group;
c. if present, discarding from said selected group the B frames that are positioned between the primary I frame of said GOP and the next I or P frame, in the encoded order;
d. decoding and storing the remaining frames of said selected group; and
e. loading for display at least one of said decoded frames in a reverse display order.

2. A method according to claim 1, where all the remaining decoded frames are loaded for display.

3. A method according to claim 1, where the remaining decoded frames are loaded for display excluding the primary I frame.

4. A method according to claim 1, where the remaining decoded frames are loaded for display excluding the subsequent I frame.

5. A method according to claim 1, where the storing of the frames is done in a buffer that is capable of storing more than 2 average GOPs of decoded frames.

6. A method according to claim 5, where part of the buffer is used for loading one GOP while another part of said buffer is used for storing another GOP.

7. A method according to claim 1, where the temporal closest decoded frame that precedes the subsequent I frame is used for error resilience in case said subsequent I frame is corrupt.

8. A method according to claim 1, where the video stream is encoded according to any one of the following standards: MPEG-1 MPEG-2 or MPEG-4.

9. A method according to claim 1, where the video stream is encoded according to the H.264 standard.

10. A method according to claim 1, where a reference frame, not part of the selected group, of a frame of said selected group, is substituted by the closest temporal decoded frame of said selected group.
